(19) United States
(12) Patent Application Publication
(10) Pub. No.: US 2008/0229561 A1
(43) Pub. Date: Sep. 25, 2008

(54) Crutch Fastener for Inverted Crutch

(76) Inventor: Robert Hondel, Graham, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/688,140

(22) Filed: Mar. 19, 2007

(51) Int. Cl. A61H 3/02

(52) U.S. Cl. 24/586.11; 135/68

(57) ABSTRACT

Disclosed is a fastener for use on or with a pair of crutches; crutches joined through use of the fastener form a self-stable geometry which permits the crutches to stand without support. The fastener is inexpensive, easy to use, and may be included on or with a wide range of different crutch types. Crutches so equipped provide benefits to users, who find it easier to store crutches without having to lay the crutches down.

### BACKGROUND

Crutches date back to prehistory, with the earliest historic record of a crutch-like object being a carving of a crutch-like staff found on an Egyptian tomb, reportedly dating to 2830 B.C. Over the years, several different types of crutches have come into widespread use, such as the forearm crutch (also referred to as “Canadian” or “elbow” crutches), the underarm or axillary crutch, the Strutter-style crutch (“Strutter” being a registered trademark of Orthotic Mobility Systems, Inc.), the platform crutch, and the knee support crutch.

The distinction between a crutch and a cane is elusive, as both may be used for enhanced stability and to transfer weight or load bearing from one or both legs to one or both arms and/or the upper body. The USPTO class 135/65 defines “canes, sticks, crutches, and walking aids” as, “Subject matter relating to cane, stick, crutch or like structure designed to aid in human locomotion, and to similar structure in umbrella shafts and swagger sticks when equally useful therefor.” UPSPTO class 135/68 defines “crutches” as, “Structure comprising shaft structure wherein the lower end engages the walking surface, the upper end engages the user at the armpit or arm above the wrist, and handhold structure is provided between the upper and lower ends.” The definition of “crutch” used in this disclosure is similar, but with additional criteria (provided further below).

When not in use, crutches are commonly placed on the floor or laid on another flat surface or they are leaned against objects. Laying crutches down is often not satisfactory because of the space they occupy, because the user must lean or bend over to pick the crutches up, because suitable flat surfaces other than the floor are often unavailable, and because of the hazard that crutches can present to the user and other people when placed in such a position. Leaning a crutch or crutches against an object is often not satisfactory because of the ease with which the crutch may slide along the object and fall to the floor. To increase the stability of the leaned crutch, many parties have found that certain crutches may be inverted. When inverted, the armpit or arm engaging structure found on many crutches serves as a flat or multi-point surface which provides some stability. For example, the American Academy of Orthopaedic Surgeons recommends that when a person using crutches sits down, that the crutch user, “Lean your crutches upside down in a handy location. (Crutches tend to fall over when they are stood on their tips.)” See, “How to Use Crutches, Canes, and Walkers,” produced by the American Academy of Orthopaedic Surgeons and provided with this document.

Special purpose crutch holders and stands have been developed to address the question of what to do with crutches when not in use.

U.S. Pat. No. 6,820,854, “Stand for a walking stick and crutches,” describes a stand with tubular structures into which crutches may be placed. The stand, however, is a separate device which must be transported, which may be difficult for a person who is already using crutches.

U.S. Pat. No. 6,688,575, “Cane Stand,” describes a platform stand for a cane or crutch which platform stand may be clipped to the side of a cane or crutch for transporting the platform stand. While the platform stand disclosed in this patent may be more portable than a conventional stand, it is still an additional device and one which the user must manipulate. When attached to a crutch, the platform stand also increases the weight of the crutch, crutch weight being an important factor in usability.

U.S. Pat. No. 6,708,831, “Vertical support for crutches,” describes one or more retractable legs which are added to the lower portion of a crutch, which leg(s) may be deployed to provide a base to support the crutch(es) when not in use. This approach introduces moving parts and increases the complexity and weight of the crutch, and may not be suitable for axillary crutches without a substantial redesign of the lower portion of the axillary crutch.

U.S. Pat. No. 6,513,775, “Apparatus and Method for Standing Crutches,” describes a “U” bracket or crossbar which spans the two upper members (described in this patent as “bows”) above the handle of the first crutch of a pair of underarm crutches, which first crutch is stood generally upright. A second crutch is inverted and the lower portion (the portion proximate to the tip) of the inverted crutch is placed in the “U” bracket. The tip of the first crutch and the armpit engaging portion of the inverted crutch (now engaging the ground) are splayed out relative to one another, generally forming an “X” shape out of the two crutches when viewed from the side, the two crutches crossing at the location of the “U” bracket. The armpit engaging portion of the inverted crutch in combination with the tip of the first crutch creates a platform with at least three points (a tripod) which is intended to be self-supporting. The “U” bracket, however, must be removed or relocated when not in use so as not to obstruct the user's access to the handle. Fasteners and/or straps to allow the “U” bracket to be removed or relocated increase the complexity of this device. Also, the “U” bracket is not suitable for use with a forearm crutch.

U.S. Pat. No. 6,561,206, “Crutch coupling system” describes a magnetic coupler to hold two crutches in a static relationship. The disclosed coupler is not designed for use with inverted crutches, would not generally be suitable for incorporation into the tip or lower portion of a crutch, and provides only one configuration for crutches so joined.

The art has thus not demonstrated a crutch stand, holder, fastener, or similar device which is easy to use, lightweight, versatile, inexpensive to manufacture, which itself occupies little space, and which allows a crutch to be stored in wide range of configurations.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the invention is directed to a fastener which may be attached to and/or incorporated into the bottom and/or middle portions of a crutch. The fastener may comprise hook-and-loop materials (commonly known as velour crochet or under the trademark “Velcro®,” owned by Velcro Industries B.V. LTD), snaps, clips, or otherwise any reversible fastener as described further below. The crutch must be of a variety which includes a top portion (for example, the armpit engaging portion of a axillary crutch or the arm cuff of a forearm crutch) which top portion has at least two or more points on roughly the same topographic plane, and which plane is generally perpendicular to the main shaft of the crutch. The user may invert a pair of crutches so equipped, join the fastener(s), and splay apart the crutches to form a self-stable shape.

The disclosed invention thus allows a user to store a pair of crutches without bending over and through use of an easy to use, lightweight, versatile, and inexpensive fastener. The disclosed invention's versatility and wide range of potential configurations gives the user great latitude to find a configuration which is self-stable under the circumstances and which occupies a minimum amount of space.

### BRIEF DESCRIPTION OF THE DRAWINGS

FIG. 1 depicts crutches as are known in the art in a generally upright position.

FIG. 2 depicts crutches as are known in the art, including fasteners consistent with disclosed invention.

FIG. 3 depicts an alternative fastener.

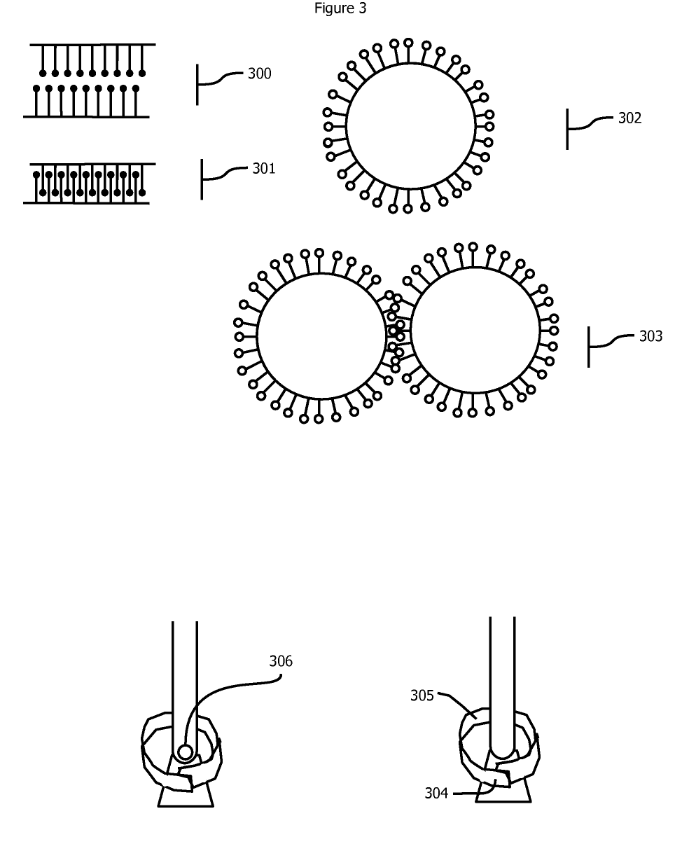

FIG. 4 depicts examples of the invention in use.

FIG. 5 depicts examples of the invention in use.

### DETAILED DESCRIPTION

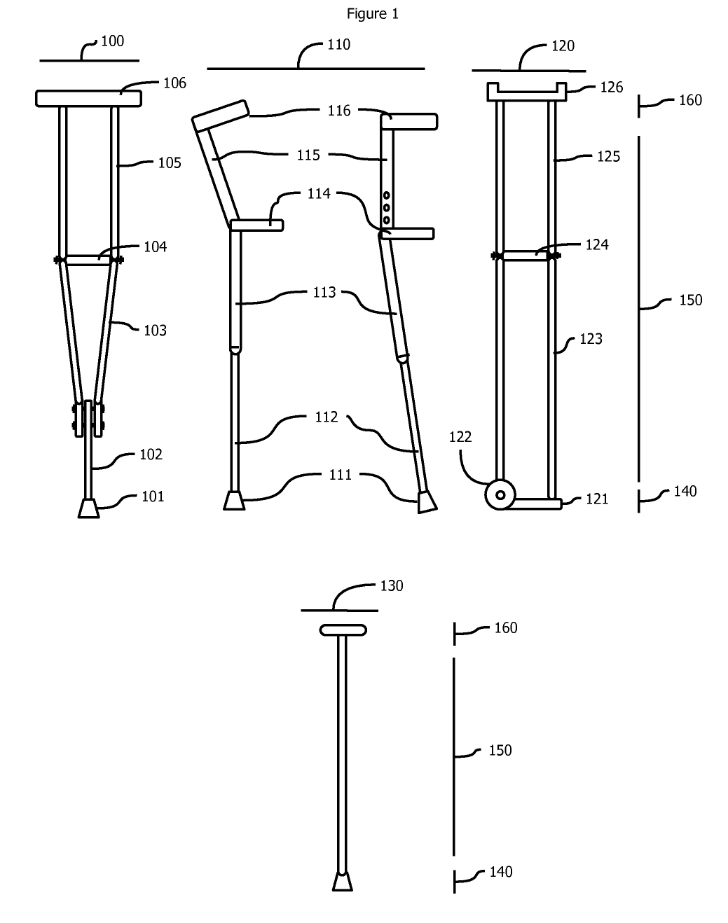

This document defines a “crutch” as any structure comprising the following minimum components: a bottom portion or tip which contacts the ground 140, a top portion 160—which top portion has at least two points on roughly the same topographic plane, and which plane is generally perpendicular to the main shaft of the crutch—and a middle portion 150 which joins the tip and the top portion, and a handle which may be part of the top portion 160 or the middle portion 150. References herein to “crutch” or “generic crutch” (and plural forms thereof) without identification of a specific crutch type (such as underarm or forearm crutch) should be understood to encompass any structure comprised of the preceding minimum components. The minimum components of a crutch are illustrated in FIG. 1 as a generic crutch 130, as discussed further below.

FIG. 1 illustrates common crutches found in the existing art and is not meant to exhaustively chart the wide variety of crutches which exist or which may exist in the art and with respect to which the disclosed invention may be applied. FIG. 1 depicts an underarm or axillary crutch 100, two versions of forearm crutches 110, and a composite crutch 120. The composite crutch 120 illustrates a crutch terminating in a tip which may be both rectangular 121 and/or wheeled 122. The rectangular tip 121 and the wheel 122 may occur together, as illustrated, may occur individually (e.g. a crutch with a rectangular tip and a crutch with one or more wheels), or may occur singly or in combination with other tips, such as a crutch with a wheel 122 and a frustoconical tip 101. If the wheel were removed, the composite crutch 120 would resemble a Strutter” brand crutch (a registered trademark of Orthotic Mobility Systems, Inc.).

FIG. 1 identifies various components of these crutch types. Beginning at the bottom (the end proximate to the ground), the crutches 100 and 110 have tips, 101, 111, 121, and 122, identified generally as the tip or bottom portion 140. Crutch tips are generally made of synthetic or natural rubber, but may be made of almost any material, including a wide variety of composites and laminates. Without limitation, the tips may be made of natural or synthetic rubber, plastic, solidified resins or other cross-linked polymers, fiber and resin laminates and composites, wood, wood laminates and composites, pure and alloyed metal, metal laminates and composites, ceramics, ceramic laminates and composites, and minerals. There may be more than one tip, such as, for example, a crutch terminating in an inverted candelabra-style platform comprising multiple tips. Crutch tips come in many different shapes, such as, for example and without limitation, frustoconical 101, 111, rectangle 121 or wheel 122. Frustoconical tips are generally round, though may be formed in a variety of shapes. The bottom of the tips may be flat, concave, convex, a complex of different shapes, and/or may have a structure adapted for contact with a particular surface, such as spikes adapted for contact with an icy surface. The tip or tips may come to a generally one-dimensional terminus, such as a point, may spread such as the frustoconical tips 101 and 111, may come to a generally two-dimensional terminus, such as a narrow rectangle 121, may comprise one or more wheels 122, or may comprise multiple such elements as shown in the composite crutch 120. Tips 140 are generally subject to wear and are generally replaceable.

Moving up from the tip 140 to the middle portion 150, crutches often then feature an extreme lower middle portion 102, 112, 123, connected to the tip 140. This extreme lower middle portion often connects to a lower middle portion 103, 113, with additional structures and components as are well known in the art and which together provide that the size of the crutch may be adjusted. Crutches also often feature a hand, handle, grip 104, 114, 124 (collectively referred to herein as a “handle”), or other component which is meant to be engaged with a hand or appendage (including a padded cup which might be used by a person who lacks a hand and/or into which an elbow may be placed). An upper middle portion 105, 115, and 125 then often joins the lower middle portion and/or the handle to the top portion 106, 116, and 126. The middle portions 150 of crutches are commonly made of plastic, solidified resins or other cross-linked polymers, fiber and resin laminates and composites, wood, wood laminates and composites, pure and alloyed metal tubing (with a wide variety of cross-sections), metal laminates and composites, ceramics, and ceramic laminates and composites.

The top portion 160 of a generic crutch may be a wide variety of structures and may itself be a handle, as depicted in 130. The top portion 160 may similarly be made of a wide variety of materials and combinations of materials, as with the middle 150 and lower 140 portions. Often, the top portion of an armpit crutch 106 is covered with a material, such as foam rubber, selected to be comfortable and/or to distribute weight and/or pressure.

Required for the invention described in this document is that the top portion 160 terminate at its highest level in two or more points, which points lie generally in the same topographic plane, and which plane is generally perpendicular to the main shaft of the crutch. For example and without limitation, armpit crutches 100 generally have a top portion 106 which comprises a roughly rectangular block, often capped with or wrapped in foam rubber or similar, and which is often concave on top to facilitate engagement with an armpit. The top portion 106 is either flat or concave and, in either event, provides at least two points at the highest level, which at least two points are generally perpendicular to the middle portion. With respect to forearm crutches 110, the top portion 116 is often a “C” shaped cuff which is meant to receive and to loosely hold the lower arm. The entire top of the cuff 116 may define a highest level which has more than two points, which points lie generally in the same topographic plane, and which plane is generally perpendicular to the main shaft of the crutch. In certain instances, the highest level of the cuff may be defined by the corners of the opening in the “C” shaped cuff, which corners define a highest level which has two points, which points lie generally in the same topographic plane, and which plane is generally perpendicular to the main shaft of the crutch. The limit of “generally in the same topographic plane” and “generally perpendicular to the middle portion” is defined by the following boundary: The plane defined by the two highest points should be close enough to perpendicular such that the crutch, when inverted, placed upon the plane, and supported from a direction perpendicular to the line defined by the two points, will not readily fall over in the direction of the line defined by the two points. If the plane is so far off perpendicular that the crutch will fall over in the direction of the line defined by the two points, then it is not “generally perpendicular to the middle portion.”

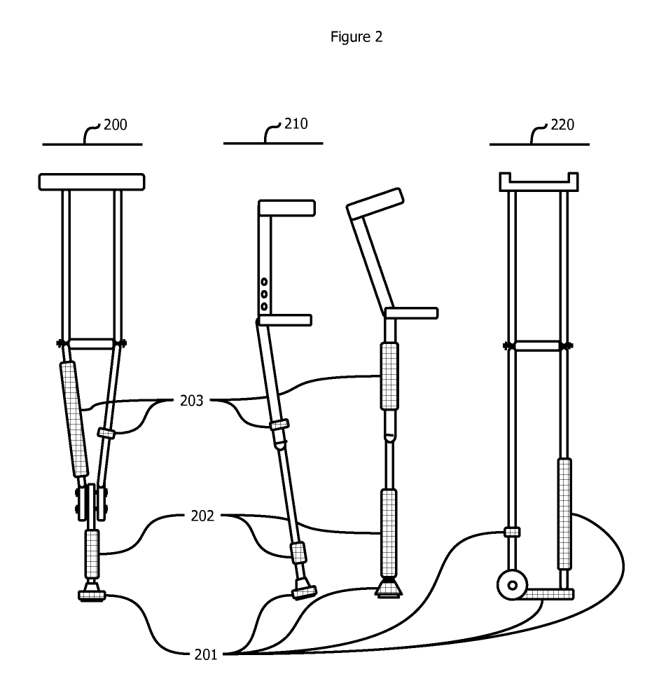

FIG. 2 illustrates crutches with cross-hatched areas 201, 202, and 203 representing a fastener or fasteners and/or general locations for the same. The areas depicted 201, 202, and 203 are non-exclusive and non-exhaustive examples only. In a preferred embodiment, the fastener is made of hook and loop material. An additional detail view of hook and loop material is not provided beyond figure 2, as hook and loop material is well known. Hook and loop material is inexpensive, is easy to use, may be applied to a wide variety of surfaces, is lightweight, provides reversible attachment, and is available with variable self-bonding strength. In an embodiment, hook material may be applied to an area of one crutch of a pair while loop material is applied to a corresponding area on the other crutch of the pair.

In another embodiment, hybrid hook/loop material, where both hooks and loops are incorporated into one piece of material, may be used. In another embodiment, a strap with hook material on one face and loop material on the other may also be attached to at least one crutch, which strap may be wound up on itself (for example, with the hook side wrapped on top of the loop side) when the strap is not in use and which strap may be unwound, wrapped around the other crutch, and re-attached to itself to fasten the crutches together.

Many alternative embodiments are possible in which a substance, material, or structure provides a fastening function. The following examples are meant to illustrate possible alternatives, not to provide an exhaustive listing. For example, male and female snaps (consisting of male and female members which reversibly interlock, generally as are well known) may be attached to and/or incorporated into corresponding areas on each of a pair of crutches; further, bands may be fitted around and/or incorporated into corresponding areas on each of a pair of crutches, which bands are comprised of a row and/or matrix of male and/or female snaps. Alternatively, a matrix of rod-ball assemblies, similar to that shown in 300 and 302, may be applied and/or attached to corresponding areas on each of a pair of crutches (encompassing partial or complete circumferential areas of the location), which rod-ball assemblies may be pushed together and pulled apart, much as is shown in 301 and 303, to serve as a reversible fastener. Alternatively, a non-drying adhesive may be applied to corresponding areas on each of a pair of crutches, though collection of debris and contaminants would shorten the useful life of such an alternative. Alternatively, a hook or clip may be attached to one of a pair of crutches, which hook or clip is chosen to accommodate the cross-section of a corresponding area of the other of the pair of crutches or which may reversibly attach to a hook or clip on the other of the pair of crutches. Alternatively, a hook may be attached to one of a pair of crutches, which hook is sized to accommodate a corresponding loop or similar structure on the other of the pair of crutches. Alternatively, a basket, such as are found on ski-poles, may be attached to one or both of a pair of crutches, the circumference of which basket is notched to reversibly grip a cross-section of the other of the pair of crutches or which is made to interlock with a structure on the other of the pair of crutches, such as with a similar basket fitted to the other crutch.

Alternatives employing an exposed hook, clip, snap, or basket may be less desirable than hook and loop material to the extent that the hook, clip, snap, or basket may become snagged on a pant leg or on other objects or material in the environment and to the extent that the hook, clip, snap, or basket provides a more limited range of attachment options. Alternatives employing a recessed or covered hook or clip may avoid the snagging problem, but would present a limited range of attachment options and/or would require greater manual dexterity to deploy and/or to join and release the fastener and/or would introduce additional mechanical complexity. A preferred fastener is also one which may be joined and which then allows the crutches to be moved relative to one another, with the fastener continuously un-joining and rejoining with some resistance, as hook and loop material will, or with the fastener gripping the corresponding structure firmly, so as to prevent undesired sliding of one crutch relative to the other, but not so firmly that the user experiences difficulty in moving the crutches relative to one another. This aspect of a preferred fastener significantly enhances ease of use.

The fastener structure or material may be located in one area, multiple areas, and/or it may cover a significant portion of the surface area of the crutch, it being conceivable that much if not the entire surface of a crutch could be covered with hook and loop or a similar material. The fastener structure or material need not entirely encompass a crutch member, but may occupy a patch or area thereon. The extent of coverage by and locations for the fastener structure or material may be determined based on a large number of other factors, such as and not limited to avoiding interference with components which allow the crutch to be adjusted, avoiding areas where application of the fastener structure or material would result in discomfort to the user, simple preference of a user and/or a crutch manufacturer and the like. In a preferred embodiment, the fastener structure or material is applied to or incorporated into the surface of the tip of the crutch 201, such as a crutch tip with hook and loop material applied to or otherwise incorporated into the tip surface.

The application of the fastener structure or material to the crutch surface may be permanent or semi-permanent, such as through use of an adhesive which provides sufficient bonding strength to prevent the fastener structure or material from being removed when the fastener structure or material is being joined and un-joined. In a preferred embodiment, hook and loop material is bonded to the crutch surface, such as onto the crutch tip. Such bonding may occur during the manufacture of the tip or the hook and loop material may be provided with an adhesive backing which would allow, for example, a user, a distributor, a manufacturer or another party to apply and bond the material according to such party's preferences. The adhesive may be selected to allow the hook and loop material to be removed, allowing the hook and loop material to be applied to a conventional crutch tip and/or to be removed and re-applied or replaced. Adhesives may be selected from the broad range of adhesives which are known in the art, whether to attached hook and loop material or to attach another fastener structure or material, such as a snap or similar which may be applied or bonded to a crutch member with an adhesive. Metal fasteners may similarly be riveted, welded, or brazed onto a crutch surface. Fasteners may also be incorporated into or bonded to a molded plastic or rubber crutch tip.

Depending on the fastener structure or material, physical attachment may also be employed. For example and without limitation, the fastener structure or material may comprise a strap or band which wraps around a crutch member, which band is provided with a second fastener(s). A second fastener (which need not be used exclusively with a band), may comprise an adhesive, a snap or similar. The second fastener may include a portion attached to a crutch member, such as a snap portion or a hook and loop material portion bonded to a crutch tip and/or to the extreme lower portion of the middle portion of a crutch, which attached second fastener portion fastens to a corresponding second fastener portion which is attached to or part of the first fastener structure or material. For example and without limitation, the crutch tip or the extreme lower middle portion of a crutch may include a female snap portion 306, which female snap portion may be fastened to a male snap portion (not shown) located on a band, which band comprises the first fastener (the first fastener being the fastener used to fasten the crutches together).

The second fastener may allow attachment of the first fastener to a crutch member through compressive force and friction, such as a band which wraps around the crutch member, is pulled tight, and which is then fastened to itself, such as through a snap, buckle, hook and loop material, or other second fastener provided for this purpose. For example and without limitation, a band of hook and loop material may have loop material on one side 304 and hook material on the other 305; the band may be pulled tight around a crutch tip so that the band overlaps with itself, with hook material facing loop material. The overlapped sections may be pressed together, as is well understood regarding hook and loop material, to fasten the overlapped band sections together, resulting in a generally continuous band of either hook or loop material wrapping around the crutch tip. A second band may be applied in a similar way to the tip of the other crutch, though with the second band reversed so that the exterior of the second band, either hook or loop material, may be fastened to the exterior of the first band.

Application of the fastener structure or material may be symmetric or asymmetric as between the two crutches, though in a preferred embodiment the application is symmetric so that the user does not need to keep track of which crutch is which.

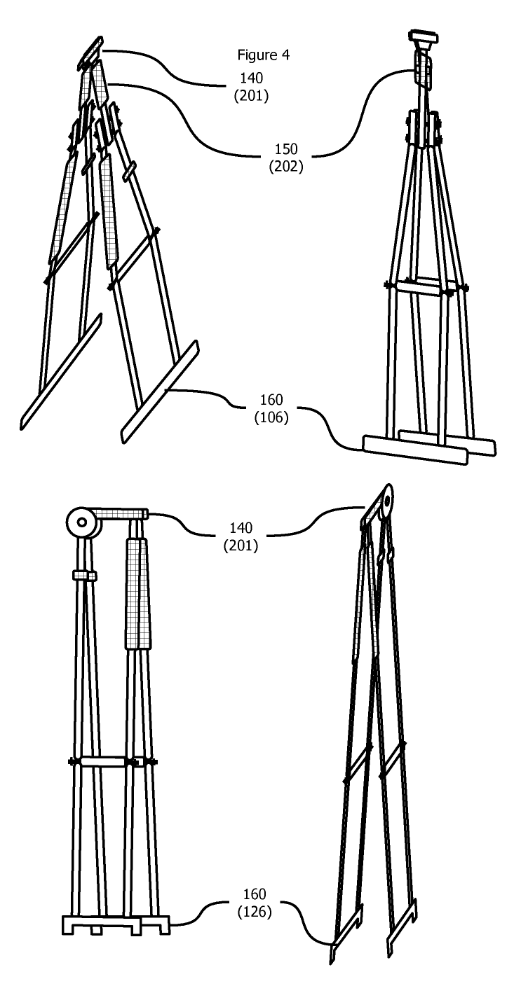

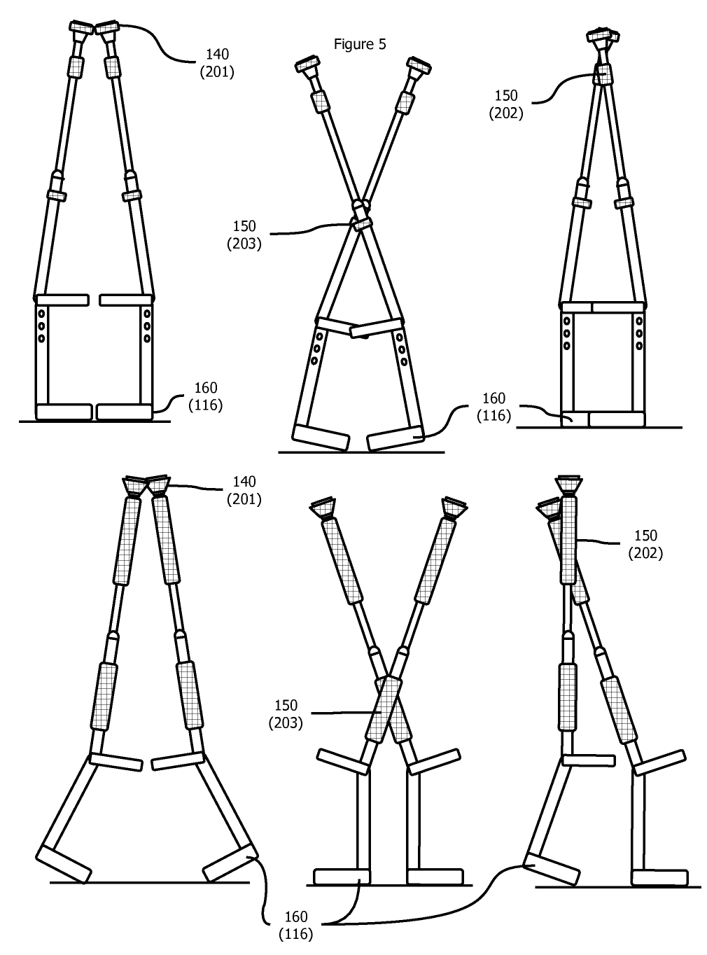

FIGS. 4 and 5 demonstrate non-exhaustive examples of use of the disclosed fastener and crutch according to this disclosure. As noted above, required for the invention described in this document is that the top portion 160 terminate at its highest level in two or more points, which points lie generally in the same topographic plane, and which plane is generally perpendicular to the main shaft of the crutch. As shown in the figures, at least one if not both of a pair of crutches is or are inverted. The top portion 160 of the inverted crutch is placed in contact with the ground. The corresponding fasteners on the crutches are joined (drawing figure numbers correspond to FIG. 1 to identify the crutch portion and to FIG. 2, in parenthesis, to identify the crutch portion detail at the location where the fasteners connect). The base of the crutches is then moved apart to form a self-stable platform out of the two joined crutches. As need arises, the joined fasteners are separated and the crutch or crutches returned to their normal upright position. The crutches may be placed in a wide range of positions, allowing users to find a position which is self-stable in the circumstances.

1. A crutch comprising a bottom portion, a top portion, a middle portion, and a first fastener and wherein
the top portion terminates at its highest level in two or more points, which points lie generally in the same topographic plane, and which plane is generally perpendicular to the main shaft of the crutch;
the middle portion joins the top portion and the bottom portion;
the first fastener is located at least on one of the bottom portion and/or the extreme lower middle portion;
and wherein the crutch may be inverted, stood upon the top portion, and joined to another crutch using the first fastener to form a self-stable geometry.

2. The crutch according to claim 1 where the first fastener comprises hook and loop material.

3. The crutch according to claim 1 where the first fastener covers less than a continuous circumference of the crutch member.

4. The crutch according to claim 1, where the first fastener comprises a band substantially encircling a circumference of at least one member of the crutch.

5. The crutch according to claim 1 where the first fastener includes a second fastener to attach the first fastener to the crutch member.

6. The crutch according to claim 5 where the second fastener comprises an adhesive.

7. The crutch according to claim 5 where the second fastener comprises hook and loop material.

8. The band according to claim 4 where the band includes a second fastener comprising hook and loop material which is incorporated into the band and which allows the band to be fastened to itself and where the band is attached to the crutch member through compressive force and friction.

9. A pair of crutches where at least one crutch of the pair is a crutch according to claim 1.

10. A crutch tip including a first fastener.

11. The crutch tip according to claim 10 where the first fastener comprises a band which substantially encircles the crutch tip.

12. The crutch tip according to claim 10 where the first fastener comprises hook and loop material.

13. The crutch tip according to claim 10 where the first fastener or a second fastener comprises a snap.

14. The crutch tip according to claim 10 where the first fastener includes a second fastener to attach the first fastener to the crutch tip.

15. The crutch tip according to claim 14 where the second fastener comprises an adhesive.

16. The crutch tip according to claim 14 where the second fastener comprises hook and loop material.

17. The crutch tip according to claim 10 where the first fastener is permanently bonded to the crutch tip.

18. Instructions to attach a fastener to a crutch tip.

19. The instructions according to claim 18, where the fastener comprises hook and loop material.

20. The fastener according to claim 19 where the fastener further comprises an adhesive backing.
